(19) United States
(12) Patent Application Publication
(10) Pub. No.: US 2020/0211136 A1
(43) Pub. Date: Jul. 2, 2020

(54) CONCEPT MOLECULE DATA STRUCTURE GENERATOR

(71) Applicant: 3M INNOVATIVE PROPERTIES COMPANY, St. Paul, MN (US)

(72) Inventor: Hans Rudolf Straub, Kreuzlingen (CH)

(21) Appl. No.: 16/724,590

(22) Filed: Dec. 23, 2019

Related U.S. Application Data
(60) Provisional application No. 62/786,743, filed on Dec. 31, 2018.

(51) Int. Cl. G06Q 50/22; G06F 16/901; G06F 16/9032; G06F 40/30

(52) U.S. Cl. CPC G06Q 50/22; G06F 40/30; G06F 16/90332; G06F 16/9024

(57) ABSTRACT

A computer implemented method includes receiving an input noun phrase, identifying a master type of concept as a function of meanings of the input noun phrase, generating a molecule data structure having the master type as a top level of the molecule data structure, and inserting additional concepts in the molecule data structure based on molecule data structure rules having an equivalent molecule data structure to complete the molecule data structure.

### CROSS REFERENCE TO RELATED APPLICATION

This application claims the benefit of U.S. Provisional Patent Application No. 62/786,743, filed Dec. 31, 2018, which is incorporated herein by reference in its entirety.

### BACKGROUND

Document coding is generally a process of mapping topics included in a document to a code of a code-set. The topics in different scenarios may simply be words but may also, or instead, be the real interest is in the semantic meanings of one or more words, sentences, and paragraphs within a document which is its semantics, consisting not of words but of concepts. The code-set to which a document is mapped may be unique to an organization or purpose but may instead be a standardized code-set as set by an industry organization, a government entity, a company, or as may be needed to integrate code-set data with a particular computer system or computing environment. Regardless, document coding is performed for many reasons such as organizing, indexing, inventorying, billing, and the like. The documents may be of different types for these purposes, such as legal documents which may include evidentiary documents, medical records of procedures and services provided, academic and technical articles and papers, and others.

Initially, document coding was performed manually. There has been an ongoing effort for electronically processing documents for automatic coding. These efforts have progressed but are generally rule-driven. Such rules often provide one-to-one or many-to-one mapping of words or a semantic meaning to one code. These rules are typically inflexible, difficult to define and update, and generally expensive to maintain due to hard-coding within computer programs or components thereof and the computer code and complexity of the rules generally being inaccessible to non-expert computer-coding employees.

### SUMMARY

A computer implemented method includes receiving an input noun phrase, identifying a master type of concept as a function of meanings of the input noun phrase, generating a molecule data structure having the master type as a top level of the molecule data structure, and inserting additional concepts in the molecule data structure based on molecule data structure rules having an equivalent molecule data structure to complete the molecule data structure.

The molecule data structure is based on a semantic net that represents the semantics of a specialty domain in a most complete and structured manner. The molecule itself represents the semantics of the input noun phrase and is a cutout of the semantic net. manner. The method may include assigning codes based on the completed molecule data structure, wherein the codes correspond to semantics of a specialty subject.

### BRIEF DESCRIPTION OF THE DRAWINGS

FIG. 1 is a block flow diagram that shows an input noun phrase to be converted into codes according to an example embodiment.

FIG. 2 is a block diagram of a computer implemented method executed to build data representations of semantic graphs of text to be coded according to an example embodiment.

FIG. 3 is an example of a concept molecule (CM) derived from the input noun phrase “open fracture of distal radius” according to an example embodiment.

FIG. 4 is a representation of a part of a semantic net for a specialty domain according to an example embodiment.

FIG. 5 is a diagram of a detail of a semantic net, showing the binding sites (slots) of the atomic concept (node) “fracture” and in particular the slot labeled “joint involvement” with the two values this slot can bind, according to an example embodiment.

FIG. 6 is a graphical representation of a CM including two questions that are generated by application of the rules to the CM according to an example embodiment.

FIG. 7 is a graphical representation of a rule molecule which creates a question for completing the concept molecule according to an example embodiment.

FIG. 8 is a logical block diagram of a system architecture for use in generating concept molecules and converting the concept molecules into codes according to an example embodiment.

FIG. 9 is a diagram illustrating a computer implemented method of generating a molecule data structure from an input noun phrase according to an example embodiment.

FIG. 10 is a flow diagram illustrating an interpretation chronology of applying rules to an input noun phrase according to an example embodiment.

FIG. 11 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Coding of documents, such as physician notes regarding a patient encounter, has been done manually for many years. Computer aided approaches have involved attempts to directly generate codes based on the words in an input noun phrase. Such attempts have proven cumbersome to create, and inaccurate in use.

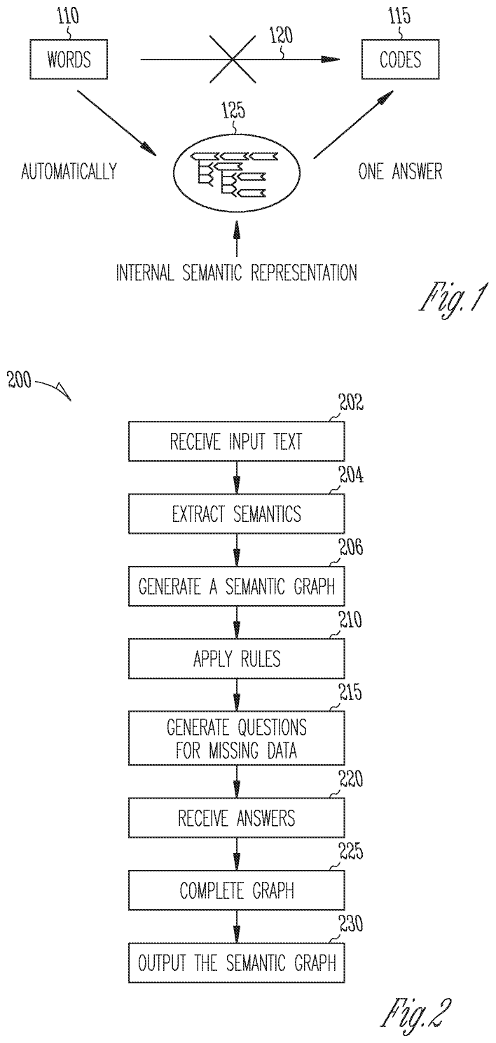

FIG. 1 is a block flow diagram 100 that shows an input noun phrase 110 to be converted into codes 115, such as medical codes for example. Coding may be performed in many other domains in addition to the medical domain. The prior method of directly coding is represented by line 120 with an “x” therethrough. Embodiments of the inventive subject matter do not follow the direct path represented by line 120, instead using an indirect path by creating an internal semantic representation 125 of the text 110 before coding.

The method of coding input noun phrases involves the use of creating a semantic representation 125 of the noun phrase, and then using the semantic representation to generate codes 115. The semantic representation incorporates the meaning of words into a graph format based on the meanings of words in a particular specialty domain, such as medicine. The resulting semantic graph (concept molecule) is then interpreted further and codes 115 are assigned to it, which represent the coding of its semantics according to a particular coding system of the domain. Usually the codes contain less information than the semantic representation, since they are simplifications (classifications) of the wide range of variations of the entities in the domain. In various embodiments of the present inventive subject matter, a set of rules having the same molecule data structure may be used to complete the semantic graph representation received so far. This is for example used to represent implicit information, like the fact that “diagnosis<pneumonia” affects the organ<lung”. Generating the code from the completed graphs becomes much more efficient, i.e. in the end, less rules for processing are necessary and this economy makes it easier to build and maintain the knowledge bases.

The molecule data structure is based on the semantics of the specialty itself. It is not closed as all coding systems and other standards (SNOMED e.g.) must be, but open and able to adjust to any of the many diverging standards. The molecule data structure is not simply hierarchical, but multidimensional-multifocal. This means that it incorporates many hierarchical trees and interweaves them to an elaborate semantic net.

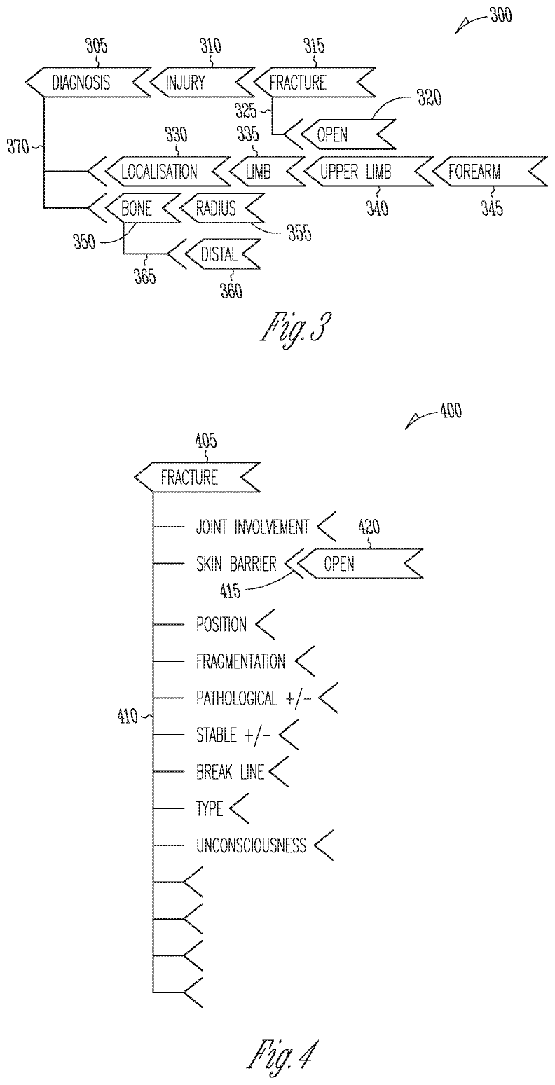

FIG. 2 is a block diagram of a method 200, according to an example embodiment. The method 200 is an example of a computer implemented method that may be executed to build data representations of semantic graphs of text to be coded. While FIG. 2 appears to imply an order to operations, there is no express temporal order intended.

The method 200 includes receiving at operation 202 input text and extracting semantics via operation 204 therefrom. In doing this, the method 200 generates at operation 206 one or more semantic graphs for the extracted semantics. Operations 204 and 206 work together rather than in any particular order. All operations are directed by rules 210, which have an equivalent structure as all other semantic graphs based on the semantic net of the specialty domain. The rules are applied by matching them to the semantic graphs received by the information process up to the momentary state. They are able to detect data missing from the graph. Based on the missing data, the rules may provide questions at operation 215 to obtain answers. In operation 220 the answers are received and the semantic graph is then completed at operation 225. With or without questions, the process ends in outputting one or more semantic graphs 230, such as to a calling process or as data stored to a data storage device or a memory device. The output 230 may also be used in a UI for an interactive coding system.

In some specific embodiments, received 202 input text may be intended for a coding defined for a particular purpose, such as by a governmental body, a consortium, a standard setting group, and the like. Some such coding schemes may be for medical billing, which may include facility and professional reimbursement fact coding elements. Examples of such medical billing codes include codes associated with the International Classification of Diseases (ICD) codes (versions 9 and 10), Current Procedural Technology (CPT) codes, a Healthcare Common Procedural Coding System codes (HCPCS), and Physician Quality Reporting System (PQRS) codes. In some examples, the codes associated with facility reimbursement include ICD codes, CPT codes, and HCPCS codes. Generally, these reimbursement facts are related to the services and equipment provided by the facility where the patient encounter occurred. Codes associated with professional reimbursement may include ICD codes, CPT codes, and PQRS codes. Generally, these reimbursement facts are related to the services and equipment provided by the attending medical professional. In other examples, the facility and professional reimbursement facts may include any medical billing codes.

The extraction of semantics via operation 204 is a natural language processing in its proper sense, the findings of which are utilized to generate a semantic graph. The natural language processing is performed to find meaning from words. The meanings are represented by the concepts of the semantic graphs. There is a distinction between atomic (single, simple and indivisible) and molecular (composite) concepts. The atomic concepts (concept atoms) are the building blocks of the composite concepts (concept molecules). Concept molecules are represented in semantic graphs as data structures built from atoms that are arranged considering the semantic relations between them. The arrangement distinguishes between hierarchic and attributive relations.

In the graphical representation of a molecule, hierarchic relations are shown horizontally and attributive relations vertically. The hierarchic relation is between a concept and its subconcepts, the attributive one between a concept and its attributes. The concept molecule is thus a well-structured composite of atoms linked together with clearly distinguishable hierarchic and attributive relations. The resulting structure is in detail described by H. R. Straub in the book “Das Interpretierende System” (Z/I/M Verlag, 2001).

A semantic graph includes at least a concept molecule with at least an atom but may also include one or more other concept molecules that each include one or more atoms. Thus, a conceptual semantic graph may be referred to as at least one concept molecule built from at least one atom. In some embodiments, a code of a coding scheme to which a concept molecule has been associated may be included as an atom of the concept molecule.

The content of a noun phrase, i.e. its semantics, is more than just the words of the phrase. What is lacking if you look only at the words are the implicit contents additional to the words and the implicit connections of all the concepts activated by the words. Both are made explicit in concept molecules (CMs).

FIG. 3 is an example of a CM 300, derived from the input noun phrase “open fracture of distal radius”. CM 300 consists of eleven atomic concepts bound together to one composite structure which is referred to as the concept molecule (CM). CM 300 is a cutout of a semantic net that represents the semantics of a specialty domain in a most complete and structured manner and which cutout represents the semantics of the input noun phrase.

The CM 300 is composed of atoms. The first line of the CM 300 includes three atoms, diagnosis 305, injury 310, and fracture 315. The fracture atom 315 has an attribute of open 320. The open attribute 320 is shown as related to the fracture atom 315 by a link 325. Attributes are also atoms.

The links between the atomic concepts are represented in the CM structure in a way that shows how the single atomic concepts are arranged. Every atom on the same line is of the same semantic type, e.g. all three atoms 305, 310, and 315 of the first line are of the type “diagnosis”, all four atoms 330, 335, 340, and 345 of the second line of the type “localization” and all two atoms 350 and 355 of the third line of the type “organ”. At the same time the two lines of “localization”, atom 330 and “bone” atom 350, represent attributes of the atom “diagnosis”. The “open” atom 320 represents an attribute of “fracture” and the “distal” atom 360 represents an attribute of “bone” and is linked as shown at 365. Atoms 330 and 350 are linked to diagnosis atom 305 via link 370.

CM 300 shows many implicit meanings, not literally mentioned in the input text. Concepts like “diagnosis”, “injury”, “limb”, “upper limb”, “forearm” and “bone” are all covered by the input, but not explicitly mentioned. They appear explicitly in the CM.

The structure of CM 300 only shows atoms and links which are necessary for the content found in the input text. The structure, however, behind the concept molecule, i.e. the semantic net, has potentially links to more types of attributes than just the ones shown in CM 300.

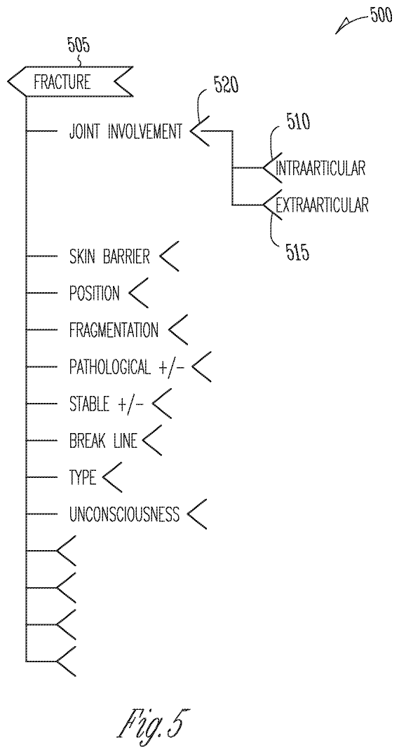

FIG. 4 is a representation of a portion 400 of a semantic net for a specialty domain. It consists of two atomic concepts, namely “fracture” and “open”, the attribute sites of the concept “fracture” and the connection between the two atomic concepts. In this instance, it represents a fracture 405 in a medical domain. The Atom “fracture” 405 is a node in this semantic net. Atom 405 includes all its attribute types (slots). The slots are shown as small chevrons under the atom “fracture” and linked to it by a vertical line 410. In FIG. 4, only the slot for skin barrier 415 has a value, i.e. atom “open” 420, defined by the input text (open fracture of distal radius) corresponding to CM 300, the other slots are left unoccupied at the moment.

Each slot under an atom represents an attribute type of the concept stated by the atom and can be assigned several values, all values of course being values of the same attribute type. Values of other attribute types are linked to other slots. In this way each slot bundles all attributes of exactly one semantic type (like joint involvement, skin barrier etc.).

FIG. 5 is a representation of a portion 500 of a semantic net. It shows the bundled values 510, 515 for the slot joint involvement 520 of the atom “fracture”. Both values “intraarticular” 510 and “extraarticular” 515 are potential values of this slot 520. The two values extraarticular and intraarticular exclude each other, which is typical for the values of a given slot. For a code ICD-10 GM (one example medical coding system) the input noun phrase “open fracture of distal radius”, is not sufficient for a precise code. A set of rules has been developed to ensure that the resulting semantic net for the input noun phrase is complete.

In one embodiment, the rules have associated questions for completion of the semantic structure.

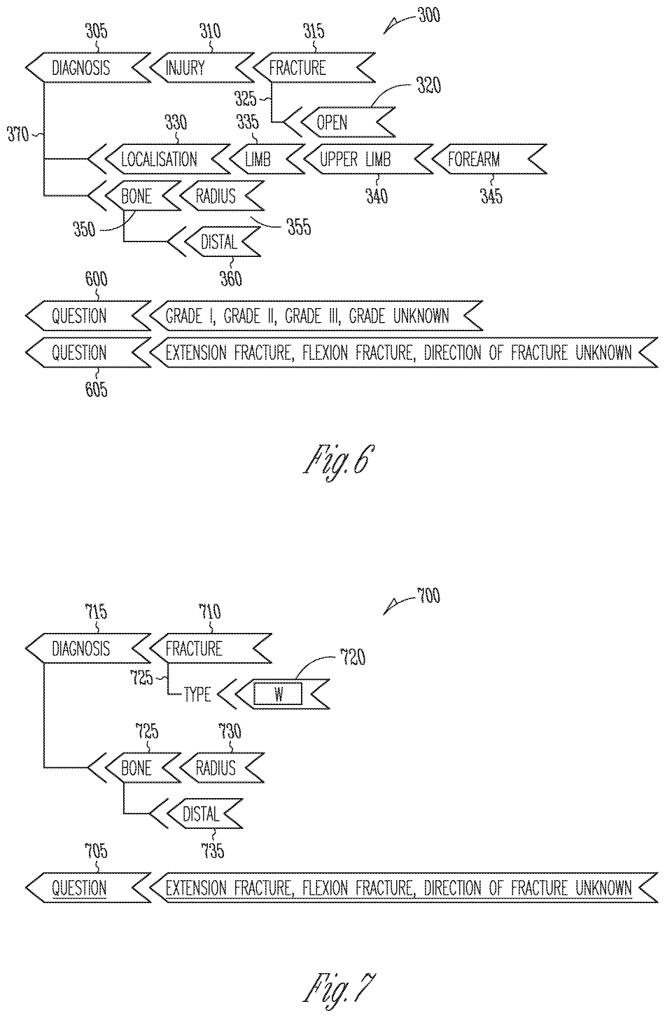

FIG. 6 is a graphical representation of CM 300 including two questions, 600 and 605 that are generated by application of the rules to the CM 300. The questions are raised by the input “open fracture of distal radius” and represented as molecules during the process of interpretation. The first question 600 asks for the grade of the soft tissue damage and the second question 605 asks for the direction of the fracture.

In one embodiment, the questions are presented to the user as a set of possible answers according to the specialty domain coding. As an example, the possible answers for question 600 are:
Grade I
Grade II
Grade III
Grade unknown

The user may click on the answer which fits the case and the answer text is added to the input which is processed anew by a coding engine, this time with more information to update the CM. The user is asked to answer all questions in order to arrive at a precise coding.

Information relevant for the coding in effect is asked by the questions in the rules based on a knowledge base. Not all information that could be given is relevant. For example, the question for the direction of the fracture is not necessary for most fractures and is selectively asked by a radius fracture which is distal. Therefore, the question rules also carry the conditions for the grounds to raise them, in FIG. 6 these are especially the atoms 710, 720, 730 and 735. If they would not be present in this constellation in the input, the rule 700 would not match and the question 705 would not be raised.

Since coding systems vary and change in time and the questions are asked selectively, it is important that the questions can be constructed in an easy way. For this goal the above-mentioned CM structure is perfectly appropriate.

All rules are explicit and are used to interpret and modify a given text input. The same kind of rule may be used to add implicit meanings, as well as to generate questions. The rules are written as molecules (dynamic molecules) with the same internal concept structure as the declarative molecules (static molecules). For the application of a rule, its structure is compared to the structure of the present state (static molecule) of the interpretation so far. To be applied a rule must match positively to the input, i.e. the present interpretation state. This means that all atoms declared positive by the rule are present in the interpretation, and all atoms declared negative are not present. Additionally, the rules can retrieve the occupation of a slot: Are there in the present input molecule already concepts bound to the slot or has a specific slot a vacancy?

FIG. 7 is a graphical representation of a rule molecule 700 which creates a question 705 for completing the concept molecule. The question 705 is raised for the concept fracture 710 in the diagnosis molecule 715 with all its specifications as shown in the upper molecule in rule 700. On the second line of this diagnosis molecule 715 there is a slot 720 for the type of the fracture. The atom “_w_” in a rectangle is a way to indicate that the slot must be vacant. This is a condition for the creation of the question 705, also a molecule, as well the existence of the atoms “bone” 725, “radius” 730 and “distal” 735 in the input, indicating the special situation for which the question is created, namely a fracture of the distal radius.

In other situations, the specification “extension/flexion” is not mandatory for coding. With CMs such questions can be made very specific—as well as for the existing situation, for which the question is asked as for the coding system, for which codes should be applied.

Since molecules have an internal structure which systematically reflects their semantics, the creation of a question can make use of this internal structure. In the case of a fracture, the atomic concept “fracture” has several slots (see FIG. 5), each of these slots bundling attributes of the same semantic quality.

The rule 700 which creates the question 705 uses this structure in two ways:
a) The question itself enumerates just values of this slot
b) The rule itself uses the slot and inquires if it is empty.

Therefore, the question is shown to the user, when the slot is empty, i.e. when the input has no information in the semantic dimension (“type”) of the slot yet. The searched information could well be implicit and would be added in this case by a rule executed earlier. There is no need to show the question if the slot is not empty.

In this way, the molecule structure helps to easily build the rules, in indicating clearly the positive conditions for the question (as “radius” and “bone” in FIG. 7) as well as the negative ones, i.e. the missing information, addressable by the specific empty slot (indicated by the “_w_” inside the rectangle in FIG. 7).

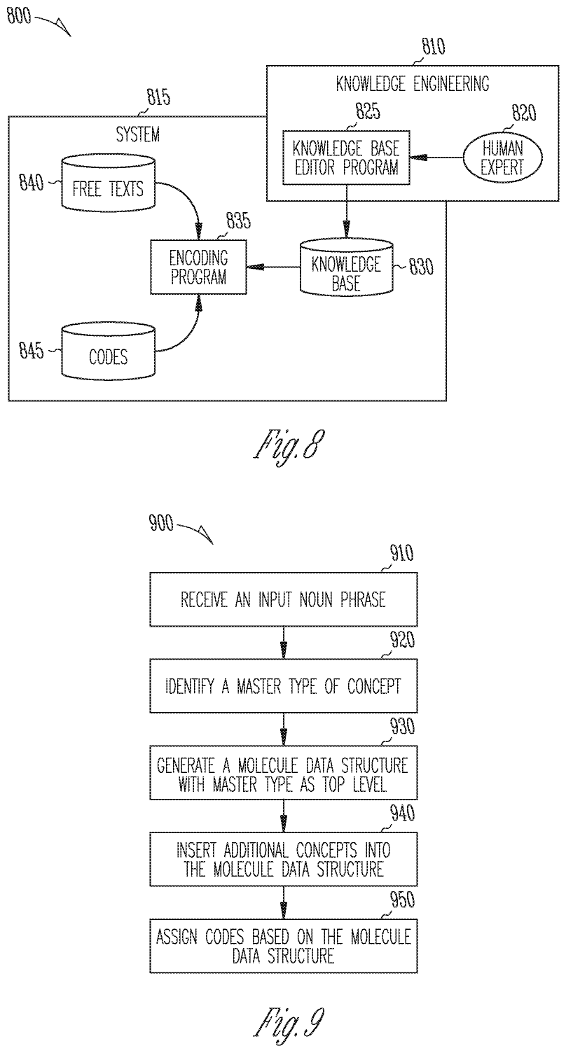

FIG. 8 is a logical block diagram of a system 800 architecture, according to an example embodiment. The system 800 includes a knowledge engineering portion 910 and a system (application) portion 815. The knowledge engineering portion takes advantage of one or more human experts 820 in the specialty domain via a knowledge base editor program 825 to capture the knowledge of the experts and generate a knowledge base 830 stored in or otherwise accessible to system 815.

An encoding program 835 receives free text, such as input noun phrases via input 840. Input 840 may be a storage device or buffer that receives text from any type of input. The encoding program 835 creates the concept molecules utilizing rules stored in the knowledge base 830. Both the concept molecules and the rules are cutouts from a semantic graph of a specialty domain. The encoding program 835 may also utilize already completed concept molecules and in this case just produce codes 845 for one or more coding systems.

FIG. 9 is a diagram illustrating a computer implemented method 900 of generating a molecule data structure from an input noun phrase in a more complete manner than previously performed. While FIG. 9 appears to imply an order to operations, there is no express temporal order intended. Method 900 begins by receiving an input noun phrase at operation 910. A master type of concept is identified at operation 920 as a function of meanings of the input noun phrase. Such identification may involve earlier processing of rules which deal e.g. with synonyms and ambiguities that are necessary to find the concept which defines the master type concept of the noun phrase. Rules which solve such ambiguities and synonyms may be resolved before arriving at the master type of concept.

FIG. 9 gives the impression of a clear sequence. But the sequence need not be fixed. The single goals may be achieved in the end, however the chronology can go many and also very complex paths. The creation and use of molecules is very open and flexible, which is one of its strengths. The order of the operations in method 900 may change depending on the input noun phrase. For example, other main types of concepts may be identified before the master type of concept is found. As more words in the phrase are processed and ambiguities are resolved, the master concept may be identified.

At operation 930 a molecule data structure is generated having the master type as a top level of the molecule data structure. Additional concepts are inserted via operation 940 in the molecule data structure based on molecule data structure rules to complete the molecule data structure. The rules have a molecule structure that is equal to the declarative molecule data structure. An associated attribute can be included in the molecule data structure either by a corresponding rule directly or by a rule with a placeholder character in it, which rule matches then in response to any or no value being provided by the input noun phrase, depending on the operator of this placeholder atom.

In one embodiment, identifying specific sites in the input molecule data structure without an associated value is done by observing the placeholder character in the corresponding data structure of the rule molecule, in order to present a question to a user, receiving an answer specifying a value for an attribute, and adding the value to the molecule data structure.

In one embodiment, the molecule data structure is a cutout of the semantic net that represents the semantics of a specialty domain in a complete and structured manner. The cutout represents the semantics of the input noun phrase.

At operation 950, codes are assigned based on the completed molecule data structure. The codes correspond to the semantics of a specialty subject, such as a medical record coding system.

The completed molecule data structure represents the semantics of the text in a most complete and structured way. Starting from this semantic molecule representation of the input text, a code of the coding system is assigned in a further process of the same nature.

Note that input molecules are considered static and rule molecules considered dynamic. Both have the same molecule data structure, but all rule molecules have additionally operators (indicators of how to match and change the input) and may also have pronouns. Each interpretation step looks at the input molecule set, finds a rule that matches it and executes the rule—with the result of a new input molecule set (=output molecule set of the present step=input molecule set for the next step). In this way the interpretation algorithm moves step to step from one input molecule set to the next one, each step guided by a matching rule.

The molecule data structure is a cutout of a semantic net that represents the semantics of text of the input noun phrase in a complete and structured manner based on semantics of a specialty domain. Identifying a master type concept from the input noun phrase comprises searching for a master type concept in a top level of the semantics of the specialty domain that matches a concept in the input noun phrase having a same semantic type. Generating a molecule data structure having the master type concept as a top level of the molecule data structure includes adding concepts of the same semantic type to the top level of the molecule data structure to provide a chain of concepts in the top level of the data structure that matches the semantics of the specialty domain.

In method 900, the interpretation of the input text is controlled by rules of a domain specific knowledge base. Stepwise one rule after the other makes a subtle interpretation change to the input, until the final molecule is created.

The rules also have a concept molecule structure and are thus also cutouts of the same domain specific semantic net as all of the concept molecules. The rules have a “dynamic” potential with which rules can transform the corresponding concept molecules. The molecules of input, output and all the intermediate states of the text interpretation are, in contrast, of purely “static” nature. The totality of the rules of an application are contained in one or more knowledge bases.

In order to execute their dynamic potential, the rule molecules have operators assigned to one or more of their atoms. The operators are used to execute the changes to the input. The search for the exact rule to apply and the application of the rule is controlled by a software program, a “semantic interpreter” which is part of the Encoding Program 935 as well as the Knowledge Base Interpreter 925. The totality of the rules of an application are contained in one or more knowledge bases 930. These are the “rule bases”, in extension to the software. They contain the algorithms (rules!) which are created and maintained by the knowledge engineers. The language of the molecules can be seen as a high-level programming language, designed to be dealt with by domain experts (knowledge engineers) and not by software engineers, adjusted to be simple, precise and potent at the same time.

The molecule data structure itself represents the semantics of the input noun phrase. It identifies a master type concept from the input noun phrase in searching for a master type concept in the semantic net of the specialty domain that matches an explicit or implicit concept in the input noun phrase having this semantic type. Completing the molecule data structure having the master type concept as its root concept includes adding all concepts found from the input noun phrase into the molecule at their proper sites. The found concepts to be added may represent a direct semantic interpretation of an input word, an additional implicit meaning inherent to an input word (pneumonia→lung) or a more complex interpretation based on two more input words.

The added concepts may either specify the master type concept and provide thus a chain of concepts in the top level of the data structure, all of the same type, namely the master type, or the concepts may be added at one or more attribute sites of the master type concept, where the added concepts represent properties of the master type.

The attribute concepts mentioned may be arranged in the same sort of chain as the chain of concepts which specifies the master type. As with the master type concept chain, where all concepts are of the same type, namely the master type, also all concepts in the chain of one property attribute are of the same type, namely the semantic type of the attribute binding site. In the semantic net, alternative attributes of the same attribute type bind at the same attribute binding site of the master type concept. In a molecule, only one concept can bind at one site; this will be one of the alternative attributes of the same attributive type or a chain starting with one of the alternative attributes. The chosen concept represents the actual choice of the specific molecule among the possible alternatives in the overall semantic net.

In a self-similar way, concepts bound to the master type concept may also act as a focus for adding further concepts, adding them either on the same line to specify the focus concept itself or at specific attribute binding sites of the focus concept in order to specify attributive properties of the focus concept. Each bound concept may again act as such a focus concept.

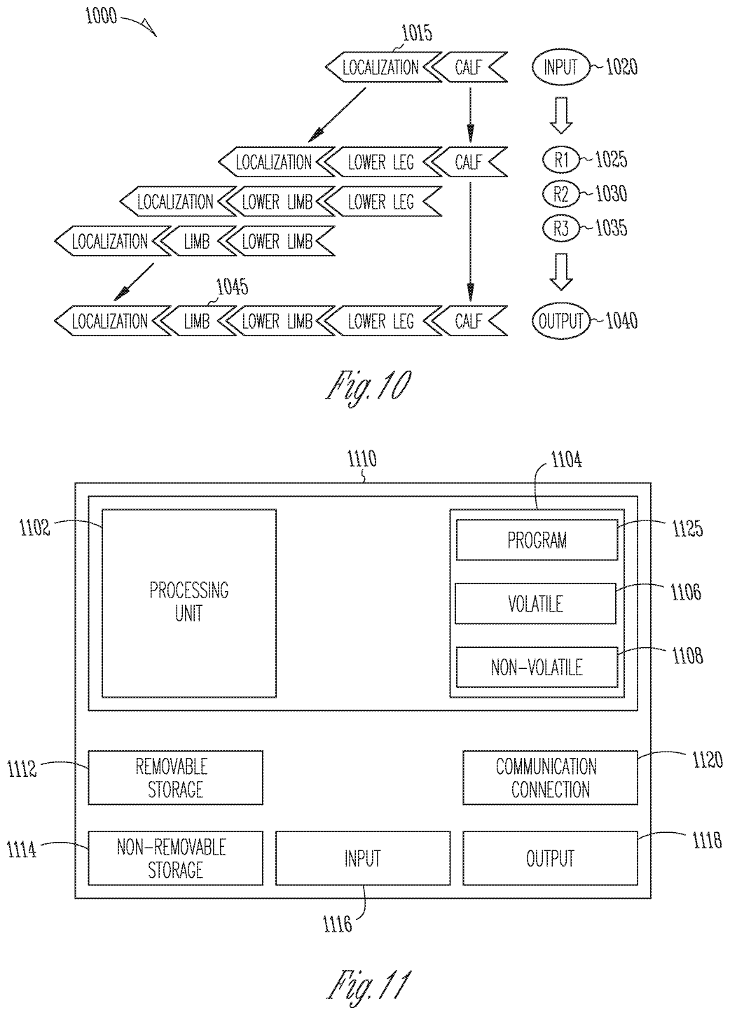

FIG. 10 is a flow diagram illustrating an interpretation chronology 1000 of applying rules to an input noun phrase. Rules are dynamic molecules. As molecules, the rules operate in a multifocal semantic space. Their IFs (conditions) and THENs (effects) are clearly settled along the axes (=Degrees of Freedom) of the semantic space. The chronology 1000 begins with an input 1020 noun phrase which is represented at begin with the concept molecule indicated at 1015. A first rule R1 1025 is matched to the beginning state of the concept molecule resulting in the concept “lower leg” being added to the state molecule. A second rule R2 1030 is now matching, adding the implicit concept “lower limb” to the molecule, followed by a third rule R3 1035 completing the concept molecule 1045 which is provided as output 1040 for conversion into a code.

This example chronology may be more complicated in further examples. As mentioned earlier the sequence/chronology may be more complicated and not as serial as shown.

FIG. 11 is a block schematic diagram of a computer system 1100 to implement the coding system and for performing methods and algorithms according to example embodiments. All components need not be used in various embodiments.

One example computing device in the form of a computer 1100 may include a processing unit 1102, memory 1103, removable storage 1110, and non-removable storage 1112. Although the example computing device is illustrated and described as computer 1100, the computing device may be in different forms in different embodiments. For example, the computing device may instead be a smartphone, a tablet, smartwatch, smart storage device (SSD), or other computing device including the same or similar elements as illustrated and described with regard to FIG. 11. Devices, such as smartphones, tablets, and smartwatches, are generally collectively referred to as mobile devices or user equipment.

Although the various data storage elements are illustrated as part of the computer 1100, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1103 may include volatile memory 1114 and non-volatile memory 1108. Computer 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1100 may include or have access to a computing environment that includes input interface 1106, output interface 1104, and a communication interface 1116. Output interface 1104 may include a display device, such as a touchscreen, that also may serve as an input device. The input interface 1106 may include one or more of a touchscreen, touchpad, mouse, keyboard, camera, one or more device-specific buttons, one or more sensors integrated within or coupled via wired or wireless data connections to the computer 1100, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1100 are connected with a system bus 1120.

Computer-readable instructions stored on a computer-readable medium are executable by the processing unit 1102 of the computer 1100, such as a program 1118. The program 1118 in some embodiments comprises software to implement one or more of the methods of generating and completing concept molecules and assigning codes to noun phrases. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 1118 along with the workspace manager 1122 may be used to cause processing unit 1102 to perform one or more methods or algorithms described herein.

### EXAMPLES

1. A computer implemented method includes receiving an input noun phrase, identifying a master type of concept as a function of meanings of the input noun phrase, generating a molecule data structure having the master type as a top level of the molecule data structure, and inserting additional concepts in the molecule data structure, the inserting directed by the molecule data structure rule best matching the molecule data structure to be completed.

2. The method of example 1 wherein the molecule data structure is a cutout of the semantic net that represents the semantics of a specialty domain in a most complete and structured manner and which cutout represents the semantics of the input noun phrase.

3. The method of example 2 and further assigning codes based on the completed molecule data structure, wherein the codes correspond to the semantics of a specialty subject.

4. The method of example 3 wherein the codes comprise a medical coding system.

5. The method of any of examples 1-4 wherein one or more additional concepts have associated attributes.

6. The method of any of examples 1-5 wherein generating the molecule data structure comprises interpreting text of the input noun phrase using rules of a domain specific knowledge base in a stepwise manner such that one rule after the other makes a small interpretation change to the input, until the final molecule data structure is created. Small changes mean “as small as possible, but not smaller”. For example, a small change is the addition or deletion of just one atom.

7. The method of example 6 wherein the rules also have a molecule data structure and are thus also cutouts of the same domain specific semantic net as all other molecule data structures, wherein the rules have a dynamic potential with which they are able to transform other molecule data structures, and contrary to these “dynamic” rules, the non-rules molecule data structures comprising inputs, outputs and intermediate states of the interpretation are of purely “static” nature and do not have the ability to change other molecule data structures, but represent a momentary state of interpretation.

8. The method of example 7 wherein the rules have operators assigned to one or more of their atoms, with which operators the method checks the matching of the rule to a given input and executes the changes to it.

9. The method of example 8 wherein associated attributes are included in the molecule data structure in response to no value being provided by the input noun phrase at this site.

10. The method of example 9 wherein including attributes is either performed by a rule calling the attribute explicitly by its name or by a rule with a placeholder character in it which acts as a signal to copy the concept to be attributed from another site of the interim state of interpretation to the correct site of the developing molecule data structure.

11. The method of any of examples 6-9 wherein the operations further comprise identifying specific sites in the input molecule data structure without an associated value by observing the placeholder character in the corresponding site of the data structure of the rule molecule.

12. The method of any of examples 6-10 wherein the operations further comprise presenting a question created by a rule to a user, receiving an answer specifying a value for an attribute, proposed by the said rule, and adding the received value to the molecule data structure.

13. A machine-readable storage device has instructions for execution by a processor of a machine to cause the processor to perform operations to perform a method of generating a molecule data structure. The operations include receiving an input noun phrase, identifying a master type of concept as a function of meanings of the input noun phrase, generating a molecule data structure having the master type as a top level of the molecule data structure, and inserting additional concepts in the molecule data structure based on molecule data structure rules having an equivalent molecule data structure to complete the molecule data structure.

14. The device of example 13 wherein the molecule data structure is a cutout of the semantic net that represents the semantics of a specialty domain in a most complete and structured manner and which cutout represents the semantics of the input noun phrase.

15. The device of example 14 wherein the operation further comprising assigning codes based on the completed molecule data structure, wherein the codes correspond to semantics of a specialty subject.

16. The device of any of examples 12-15 wherein one or more additional concepts have associated attributes, wherein generating the molecule data structure comprises interpreting text of the input noun phrase using rules of a domain specific knowledge base in a stepwise manner such that one rule after the other makes a small interpretation change to the input, until the final molecule data structure is created, wherein the rules have a molecule data structure and are thus also cutouts of the same domain specific semantic net as the declarative molecule data structures, and further wherein the rules have a dynamic potential with which they are used to transform the declarative molecule data structures comprising inputs and intermediate states of the interpretation, which are of purely static nature and do not have the ability to change other molecule data structures, but represent a momentary state of interpretation, and wherein the rules have operators assigned to one or more of their atoms, with which operators the method checks the matching of the rule to a given input and executes the changes to it.

17. The device of any of examples 15-16 wherein associated attributes are included in the molecule data structure in response to no value being provided by the input noun phrase via either by a rule calling the attribute explicitly by its name or by a rule with a placeholder character in it which acts as a signal to copy the concept to be attributed from another site of the interim state of interpretation to the correct site of the developing molecule data structure.

18. A device includes a processor and a memory device coupled to the processor and having a program stored thereon for execution by the processor to perform operations. The operations include receiving an input noun phrase, identifying a master type of concept as a function of meanings of the input noun phrase, generating a molecule data structure having the master type as a top level of the molecule data structure, and inserting additional concepts in the molecule data structure based on molecule data structure rules having an equivalent molecule data structure to complete the molecule data structure.

19. The device of example 18 wherein the molecule data structure is a cutout of the semantic net that represents the semantics of a specialty domain in a most complete and structured manner and which cutout represents the semantics of the input noun phrase.

20. The device of example 19 wherein the operation further comprising assigning codes based on the completed molecule data structure, wherein the codes correspond to semantics of a specialty subject.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving an input noun phrase;
identifying a master type of concept as a function of meanings of the input noun phrase;
generating a molecule data structure having the master type as a top level of the molecule data structure; and
inserting additional concepts in the molecule data structure based on molecule data structure rules having an equivalent molecule data structure to complete the molecule data structure.

2. The method of claim 1 wherein the molecule data structure is a cutout of the semantic net that represents the semantics of a specialty domain in a most complete and structured manner and which cutout represents the semantics of the input noun phrase.

3. The method of claim 2 and further assigning codes based on the completed molecule data structure, wherein the codes correspond to the semantics of a specialty subject.

4. The method of claim 3 wherein the codes comprise a medical coding system.

5. The method of claim 1 wherein one or more additional concepts have associated attributes.

6. The method of claim 1 wherein generating the molecule data structure comprises interpreting the text of the input noun phrase using rules of a domain specific knowledge base in a stepwise manner such that one rule after the other makes a small interpretation change to the input, until the final molecule data structure is created.

7. The method of claim 6 wherein the rules also have a molecule data structure and are thus also cutouts of the same domain specific semantic net as all other molecule data structures, wherein the rules have a dynamic potential with which they are able to transform other molecule data structures, and contrary to these “dynamic” rules, the non-rules molecule data structures comprising inputs, outputs and intermediate states of the interpretation are of purely “static” nature and do not have the ability to change other molecule data structures, but represent a momentary state of interpretation.

8. The method of claim 7 wherein the rules have operators assigned to one or more of their atoms, with which operators the method checks the matching of the rule to a given input and executes the changes to it.

9. The method of claim 8 wherein associated attributes are included in the molecule data structure in response to no value being provided by the input noun phrase at this site.

10. The method of claim 9 wherein including attributes is either performed by a rule calling the attribute explicitly by its name or by a rule with a placeholder character in it which acts as a signal to copy the concept to be attributed from another site of the interim state of interpretation to the correct site of the developing molecule data structure.

11. The method of claim 6 wherein the operations further comprise identifying specific sites in the input molecule data structure without an associated value by observing the placeholder character in the corresponding site of the data structure of the rule molecule.

12. The method of claim 6 wherein the operations further comprise
presenting a question created by a rule to a user;
receiving an answer specifying a value for an attribute, proposed by the said rule; and
adding the received value to the molecule data structure.

13. A machine-readable storage device having instructions for execution by a processor of a machine to cause the processor to perform operations to perform a method of generating a molecule data structure, the operations comprising:
receiving an input noun phrase;
identifying a master type of concept as a function of meanings of the input noun phrase;
generating a molecule data structure having the master type as a top level of the molecule data structure; and
inserting additional concepts in the molecule data structure based on molecule data structure rules having an equivalent molecule data structure to complete the molecule data structure.

14. The device of claim 13 wherein the molecule data structure is a cutout of the semantic net that represents the semantics of a specialty domain in a most complete and structured manner and which cutout represents the semantics of the input noun phrase.

15. The device of claim 14 wherein the operation further comprises assigning codes based on the completed molecule data structure, wherein the codes correspond to semantics of a specialty subject.

16. The device of claim 12 wherein one or more additional concepts have associated attributes, wherein generating the molecule data structure comprises interpreting text of the input noun phrase using rules of a domain specific knowledge base in a stepwise manner such that one rule after the other makes a small interpretation change to the input, until the final molecule data structure is created, wherein the rules have a molecule data structure and are thus also cutouts of the same domain specific semantic net as the molecule data structures, and further wherein the rules have a dynamic potential with which they are used to transform other molecule data structures comprising inputs and intermediate states of the interpretation and are of purely static nature and do not have the ability to change other molecule data structures, but represent a momentary state of interpretation, and wherein the rules have operators assigned to one or more of their atoms, with which operators the method checks the matching of the rule to a given input and executes the changes to it.

17. The device of claim 15 wherein associated attributes are included in the molecule data structure in response to no value being provided by the input noun phrase via either by a rule calling the attribute explicitly by its name or by a rule with a placeholder character in it which acts as a signal to copy the concept to be attributed from another site of the interim state of interpretation to the correct site of the developing molecule data structure.

18. A device comprising:
a processor; and
a memory device coupled to the processor and having a program stored thereon for execution by the processor to perform operations comprising:
receiving an input noun phrase;
identifying a master type of concept as a function of meanings of the input noun phrase;
generating a molecule data structure having the master type as a top level of the molecule data structure; and
inserting additional concepts in the molecule data structure based on molecule data structure rules having an equivalent molecule data structure to complete the molecule data structure.

19. The device of claim 18 wherein the molecule data structure is a cutout of the semantic net that represents the semantics of a specialty domain in a most complete and structured manner and which cutout represents the semantics of the input noun phrase.

20. The device of claim 19 wherein the operation further comprising assigning codes based on the completed molecule data structure, wherein the codes correspond to semantics of a specialty subject.
